(19) United States
(12) Patent Application Publication
(10) Pub. No.: US 2016/0318722 A1
(43) Pub. Date: Nov. 3, 2016

(54) THREE-COMPARTMENT VEHICLE

(71) Applicant: Gary Cervelli, Coram, NY (US)

(72) Inventor: Gary Cervelli, Coram, NY (US)

(21) Appl. No.: 15/142,254

(22) Filed: Apr. 29, 2016

Related U.S. Application Data
(60) Provisional application No. 62/154,300, filed on Apr. 29, 2015.

(51) Int. Cl. B65G 67/24; B60P 1/00; B60P 3/24

(52) U.S. Cl. CPC B65G 67/24; B60P 3/24; B60P 1/006

(57) ABSTRACT

A vehicle including a truck body and a cylindrical container. The cylindrical container is supported by the truck body and defines a longitudinal axis. The cylindrical container is rotatable about the longitudinal axis with respect to the truck body. The cylindrical container defines a first compartment, a second compartment, and a third compartment therein.

### CROSS-REFERENCE TO RELATED APPLICATION

The present application claims the benefit of and priority to U.S. Provisional Patent Application Ser. No. 62/154,300 filed on Apr. 29, 2015, the entire contents of which being herein incorporated by reference in its entirety.

### BACKGROUND

1. Technical Field

The present disclosure generally relates to vehicles used to collect garbage and recyclables. More particularly, the present disclosure relates to garbage trucks and recycling trucks including three separate compartments. Such trucks are useful to collect and maintain separation between three different types of recyclables, for example.

2. Background of Related Art

Trucks for collecting garbage and recycling are well known. Typically such trucks include one or two compartments for keeping various materials separate. One-compartment trucks often include a hopper on the rear portion of the truck and are generally loaded from the rear. These trucks may include a ram to help move and/or compress the garbage or recyclables toward the front of the truck. One-compartment trucks that are rear-loaded are typically emptied by moving the contents toward and out the rear of the truck, either via gravity and/or an ejector. Two-compartment trucks are also typically loaded from the rear of the truck.

In certain areas or municipalities, it may be desirable to provide a vehicle that is able to transport and maintain separation between three different types of materials. It may be further desirable to load and unload the contents onto such a vehicle from the rear of the vehicle. Accordingly, it would be advantageous to provide a three-compartment vehicle that that loaded and unloaded from the rear of the vehicle.

### SUMMARY

The present disclosure relates to a vehicle including a truck body and a cylindrical container. The cylindrical container is supported by the truck body and defines a longitudinal axis. The cylindrical container is rotatable about the longitudinal axis with respect to the truck body. The cylindrical container defines a first compartment, a second compartment, and a third compartment therein.

In disclosed embodiments, each of the first compartment, the second compartment, and the third compartment includes a pie-shaped cross-section.

It is further disclosed that the vehicle includes a ram configured to move at least partially within the cylindrical container. It is disclosed that the ram is pie-shaped.

It is also disclosed that the vehicle includes a hopper disposed adjacent a distal portion of the cylindrical container. It is disclosed that the hopper includes an arcuate bottom member having a curvature that is substantially similar to a curvature of the cylindrical container.

In disclosed embodiments, the vehicle includes an ejector assembly configured to urge material from within the cylindrical compartment distally. It is disclosed that the ejector assembly includes a pie-shaped ejector that is longitudinally translatable within the first compartment.

The present disclosure also relates to a method of collecting recyclables. The method includes positioning a first compartment of a cylindrical container of a truck in a lower position, loading a first type of recyclable at least partially into the first compartment, rotating the cylindrical container with respect to a truck body such that a second compartment of the cylindrical container is in a lower position, and loading a second type of recyclable at least partially into the second compartment.

In disclosed embodiments, the method includes rotating the cylindrical container with respect to the truck body such that a third compartment of the cylindrical container is in a lower position. It is further disclosed that the method includes loading a third type of recyclable at least partially into the third compartment of the cylindrical container.

Embodiments of the method also include moving the first type of recyclable proximally using a pie-shaped ram. It is further disclosed to move the first type of recyclable distally using a pie-shaped ejector.

In disclosed embodiments, the method includes loading the first type of recyclable onto a hopper of the truck. It is disclosed that loading the first type of recyclable onto the hopper of the truck is performed prior to loading the first type of recyclable at least partially into the first compartment.

In disclosed embodiments of the method, loading the first type of recyclable at least partially into the first compartment is performed prior to rotating the cylindrical container with respect to the truck body such that the second compartment is in the lower position.

### BRIEF DESCRIPTION OF DRAWINGS

Embodiments of the present disclosure are described hereinbelow with reference to the drawings wherein:

FIG. 1 is a perspective view of a truck having a cylindrical container in accordance with embodiments of the present disclosure;

FIG. 2 is a perspective view of a portion of the truck of FIG. 1;

FIG. 3A is a side view of the truck of FIGS. 1-2 illustrated while a first compartment of the cylindrical container is being loaded with waste;

FIG. 3B is a side view of the truck of FIGS. 1-3A illustrated while a second compartment of the cylindrical container is being loaded with waste;

FIG. 3C is a side view of the truck of FIGS. 1-3B showing both the first compartment and the second compartment of the cylindrical container loaded with waste;

FIG. 3D is a side view of the truck of FIGS. 1-3C illustrated while waste from the first compartment of the cylindrical container is being unloaded;

FIG. 4 is a rear view of the truck of FIGS. 1-3D according to embodiments of the present disclosure;

FIG. 5 is a perspective, assembly view of various components of the truck of FIGS. 1-4;

FIG. 6 is a perspective, assembly view of various components of a truck in accordance with embodiments of the present disclosure;

FIG. 7 is a rear view of a cylindrical container of the truck of FIG. 6; and

FIG. 8 is a top view of a portion of the cylindrical container of the truck of FIGS. 6-7.

### DETAILED DESCRIPTION

Embodiments of the presently disclosed three-compartment vehicle are described in detail with reference to the drawings wherein like numerals designate identical or corresponding elements in each of the several views. In the description that follows, the term “proximal” will refer to the portion of the vehicle that is closest to the front of the vehicle, while the term “distal” will refer to the portion of the vehicle that is farthest from the front of the vehicle.

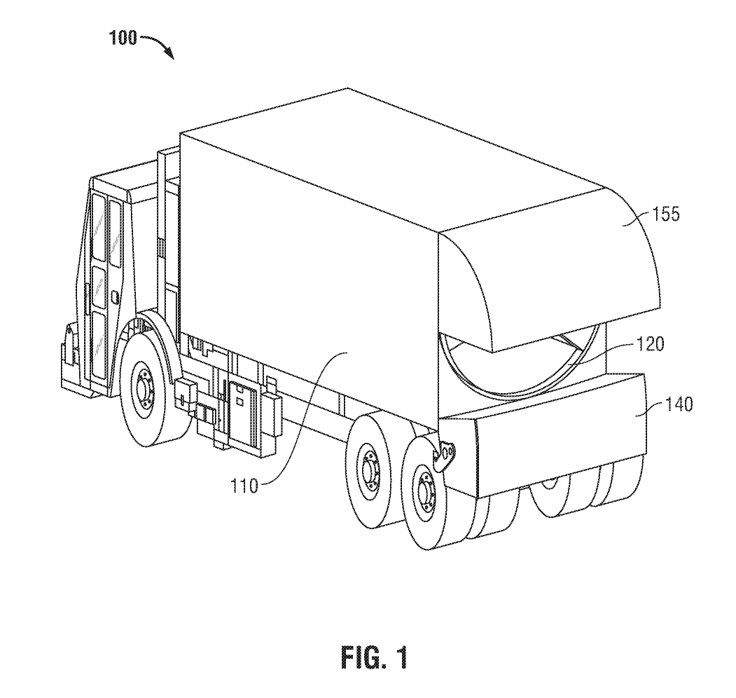

A three-compartment vehicle or truck 100 in accordance with embodiments of the present disclosure is shown in FIGS. 1-8. To the extent truck 100 is similar to a typical garbage truck or recycling truck, the details will not be discussed in detail herein. Generally, truck 100 includes a truck body 110, a cylindrical container 120, a hopper 140, a ram assembly 150, and an ejector assembly 160.

Cylindrical container 120 is supported by truck body 110, is generally hollow, and defines three compartments—a first compartment 120a, a second compartment 120b, and a third compartment 120c. In use, each compartment 120a-120c is envisioned holding a different material (e.g., recyclable “R”). For example, first compartment 120a can be used to hold a first type of recyclable (e.g., paper), second compartment 120b can be used to hold a second type of recyclable (e.g., plastic), and third compartment 120c can be used to hold a third type of recyclable (e.g., glass).

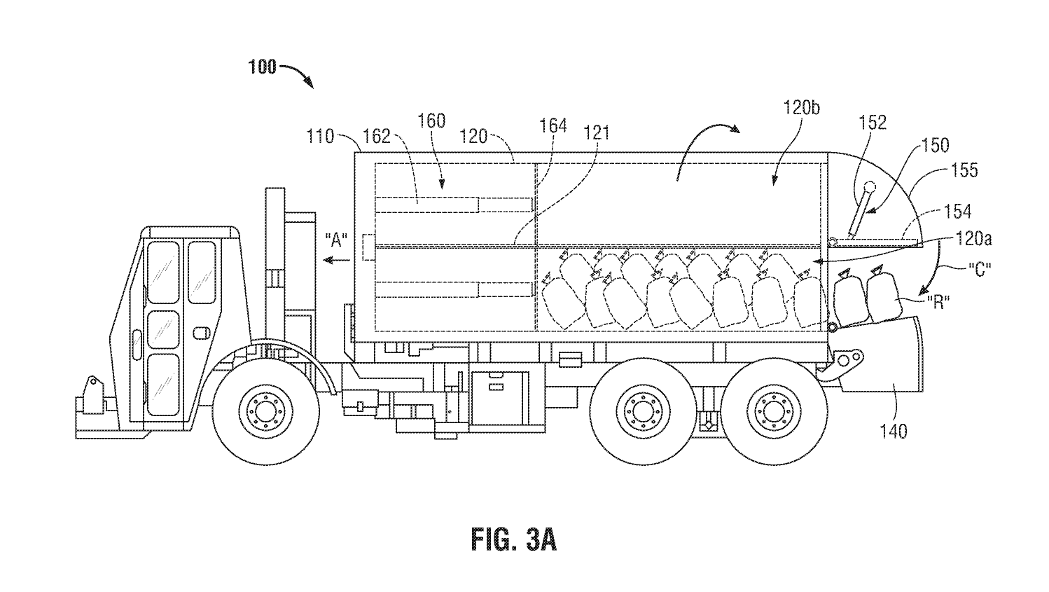

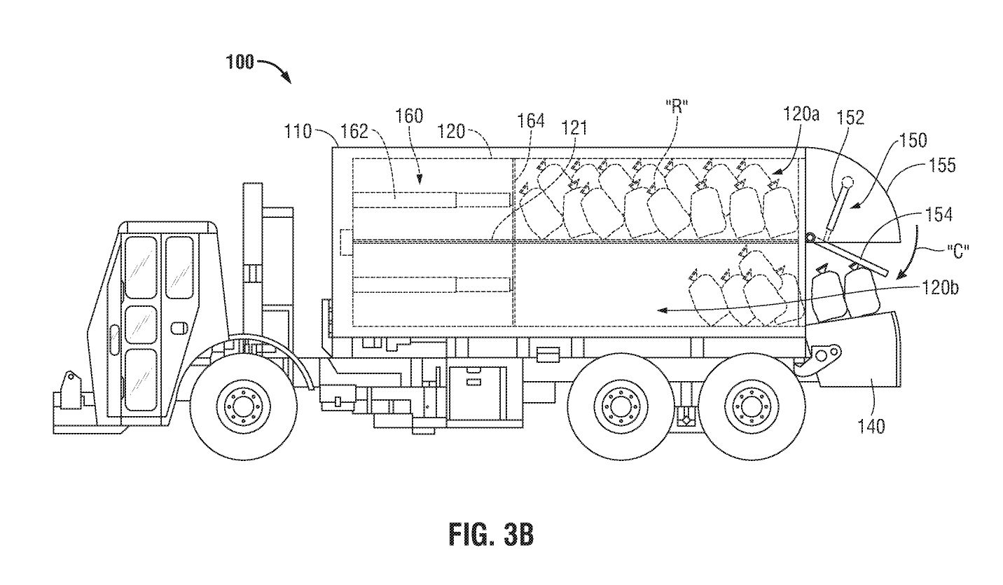

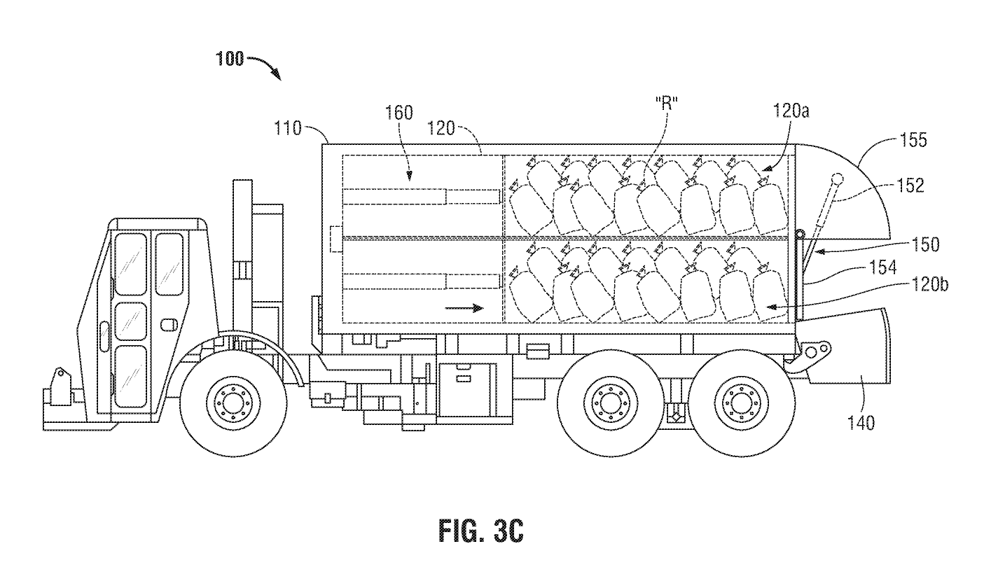

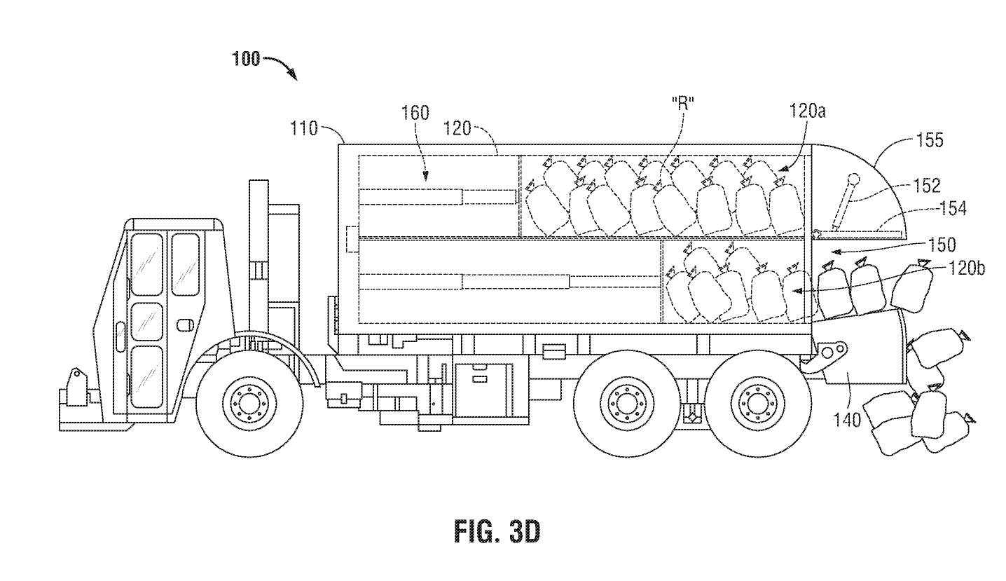

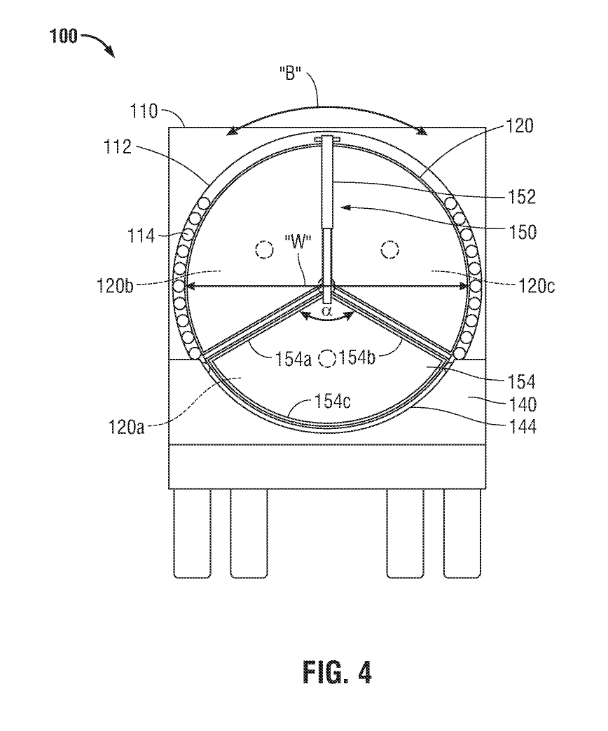

Cylindrical container 120 defines a longitudinal axis “A-A” extending through a radial center thereof, e.g. along a drive shaft 121 thereof (FIGS. 3A and 6-8). Cylindrical container 120 is rotatable about longitudinal axis “A-A” with respect to truck body 110 in the general direction of double-headed arrow “B” in FIG. 4. It is envisioned that cylindrical container 120 can be caused to rotate with respect to the truck body 110 by electro-mechanical means (e.g., by actuation of a button, switch, lever, etc.) either within a cab of the truck 100 or external to the cab, or by mechanical means (e.g., by physically rotating the cylindrical container 120 with the assistance of a handle, for instance).

In disclosed embodiments, cylindrical container 120 includes a width “w” or diameter of about six feet (FIG. 4), and a radius of curvature of about three feet. Other sizes of cylindrical container 120 are also contemplated.

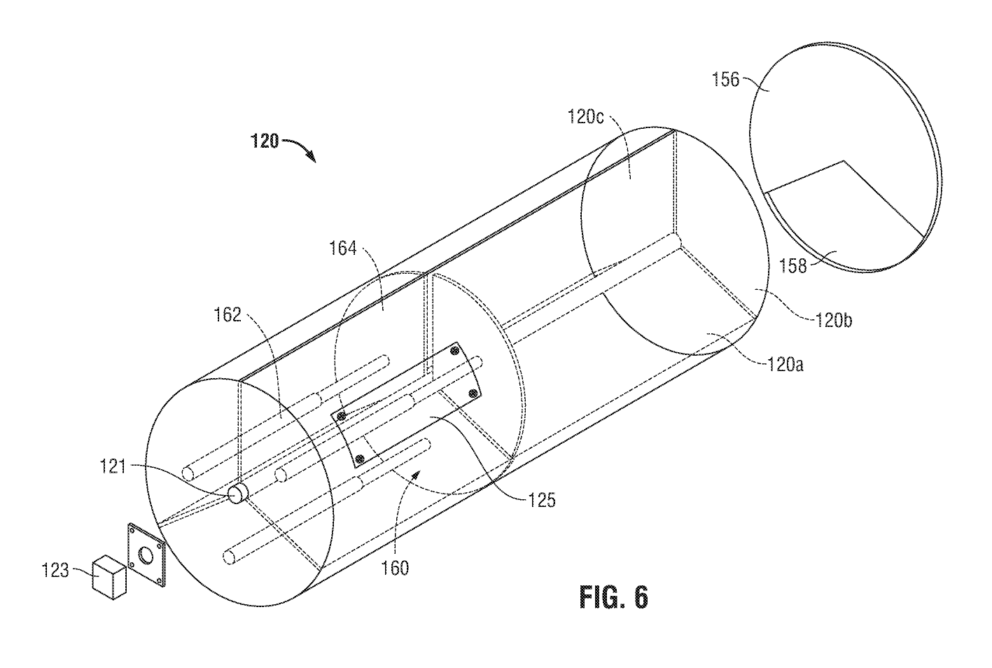

It is envisioned that truck body 110 includes an arcuate portion 112 that matches or substantially matches that radius of curvature of cylindrical container 120 (see FIG. 4). It is further envisioned that a plurality of rollers 114 or other suitable structure is disposed between truck body 110 (e.g., arcuate portion 112 thereof) and cylindrical container 120 to facilitate the rotation of cylindrical container 120 with respect to truck body 110. It is further envisioned that cylindrical container 120 can rotate with respect to truck body 110 by rotating drive shaft 121 via a motor 123 (e.g., a hydraulic motor), for example (see FIGS. 6 and 8).

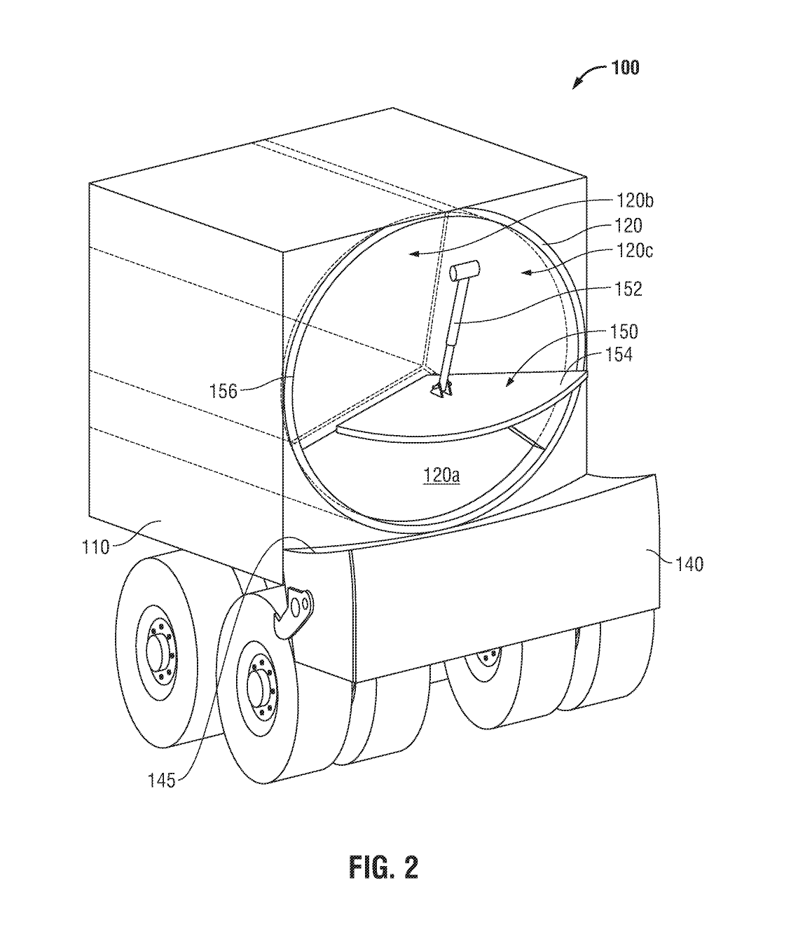

Hopper 140 is supported on a distal portion of truck body 110 and is disposed distally adjacent a distal end of cylindrical container 120. Hopper 140 is configured to hold material (e.g., garbage or recyclables) prior to that material being moved into the cylindrical container 120. It is envisioned that hopper 140 is pivotable with respect to cylindrical container 120. In disclosed embodiments, hopper 140 includes an arcuate surface 144. Arcuate surface 144 includes a curvature (or radius of curvature) that is the same as or that is substantially similar to the curvature of the cylindrical container 120 (see FIG. 4). It is further envisioned that hopper 140 includes an arcuate surface 145, as viewed from the side, as shown in FIG. 2, which can match or substantially match the range of motion of a ram 154 as it pivots with respect to an arm 152 in the general direction of arrow “C” in FIGS. 3A and 3B, as discussed below.

Ram assembly 150 is configured to move the material from the hopper 140 into a compartment 120a, 120b or 120c of the cylindrical container 120. Ram assembly 150 generally includes arm 152, and ram 154 supported by the arm 152. Arm 152 (e.g., a telescoping arm) is movable with respect to the truck body 110 by conventional means. Ram 154 is shaped similarly to the cross-sectional shape of a single compartment 120a, 120b or 120c of the cylindrical container 120. That is, ram 154 is pie-shaped and includes a first wall 154a and a second 154b wall disposed at an angle a (e.g., about 120°) from each other, and a third, curved wall 154c connected to the first two walls 154a, 154b. The third wall 154c includes the same or a similar radius of curvature as the cylindrical container 120. Arm 152 is movable to cause ram 154 to move toward or at least partially into a single compartment 120a, 120b or 120c of the cylindrical container 120, either via pivotal movement, linear movement, or a combination thereof. It is further envisioned that arm 152 is engaged with or housed at least partially within a distal member 155, as shown in FIGS. 1 and 3A-3D.

In disclosed embodiments, a distal wall 156 is also included adjacent a distal end of the cylindrical container 120 (FIGS. 2, 5 and 6). Distal wall 156 includes an opening 158 (e.g., a pie-shaped opening) on a lower portion thereof, which is configured to allow material to be passed therethrough. It is envisioned that distal wall 156 helps prevent material from distally exiting the two compartments of the cylindrical container 120 that are not on the bottom. Here, the opening 158 of the distal wall 156 would be aligned with the bottom compartment, and may also be aligned with the ram 154. Thus, a combination of the distal wall 156 and the ram 154 would help prevent material from pre-maturely distally exiting the bottom compartment of the cylindrical container 120.

Ejector assembly 160 is configured to move material from within one of compartments 120a, 120b and 120c of the cylindrical container 120 distally out of the rear of the cylindrical container 120. In lieu of or in addition to the ejector assembly 160, material can be emptied from the cylindrical container 120 by elevating a proximal portion of the cylindrical container 120 with respect to the distal portion of the cylindrical container 120, thereby using gravitational forces to empty the contents of the cylindrical container 120.

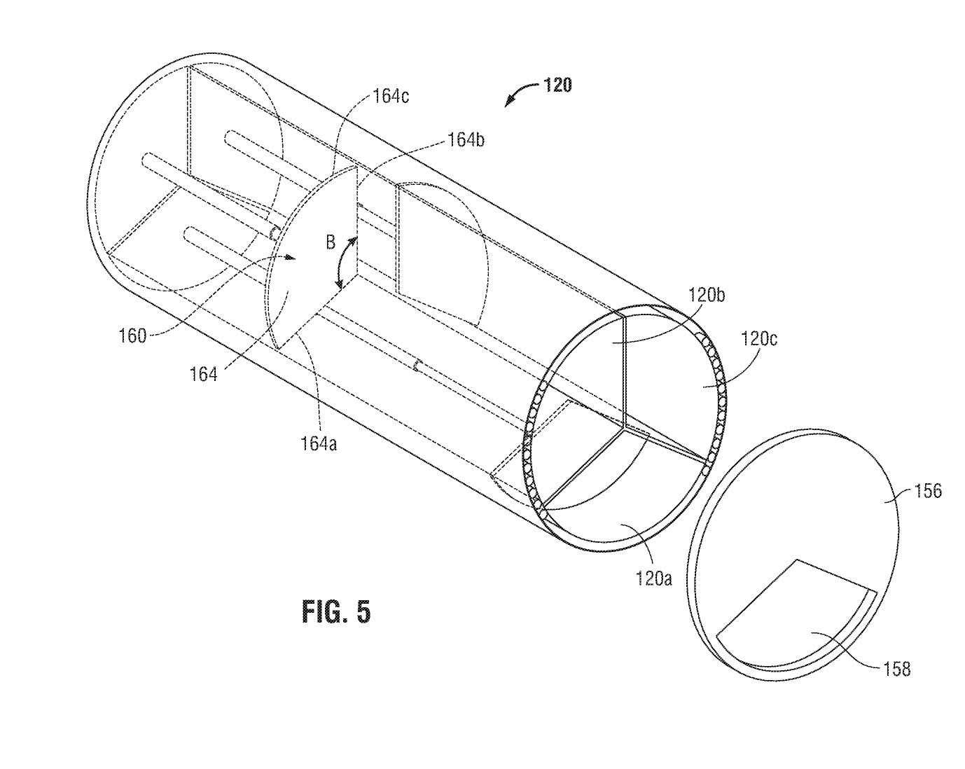

Ejector assembly 160 generally includes an ejector arm 162 and an ejector 164 supported by the ejector arm 162. Ejector arm 162 (e.g., a telescoping arm) is movable with respect to the truck body 110 by conventional means. Ejector 164 is shaped similarly to the ram 154, and similarly to the cross-sectional shape of a single compartment 120a, 120b or 120c of the cylindrical container 120. That is, ejector 164 is pie-shaped and includes a first wall 164a and a second 164b wall disposed at an angle (e.g., about 120°) from each other, and a third, curved wall 164c connected to the first two walls 164a, 164b (FIG. 5). The third wall 164c includes the same or a similar radius of curvature as the cylindrical container 120. Ejector arm 162 is movable to cause ejector 164 to move within a single compartment 120a, 120b or 120c of the cylindrical container 120, either via linear movement.

It is further envisioned the ejector assembly 160 includes more than one ejector arm 162 and ejector 164. More particularly, it is envisioned that ejector assembly 160 includes one ejector arm 162 and one ejector 164 for each compartment 120a, 120b and 120c of the cylindrical container 120. Here, as shown in FIGS. 5 and 6, for example, ejector assembly 160 includes three independently actuatable ejector arms 162 and/or ejectors 164, such that each ejector arm 162 and ejector 164 is associated (e.g., at least partially within) one compartment 120a, 120b or 120c.

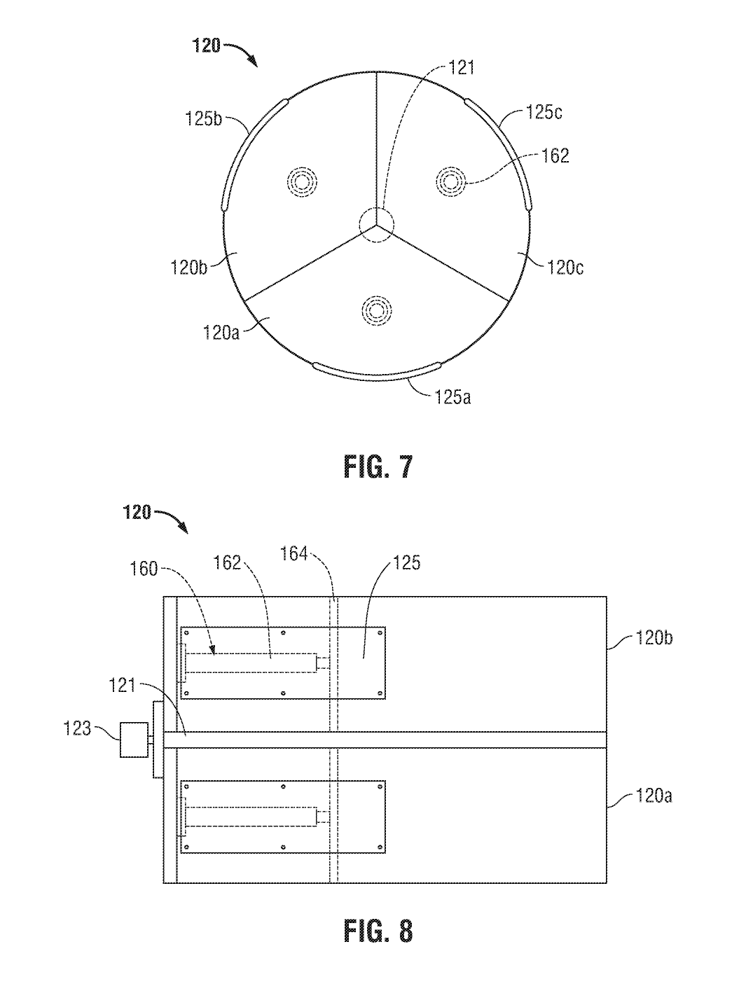

Additionally, cylindrical container 120 may include at least one access panel 125 to provide access to the compartments 120a, 120b, and 120c (FIGS. 6-8). Access panel 125 may also provide access to various controls. It is further envisioned that each compartment 120a, 120b, and 120c of cylindrical container 120 includes its own access panel 125a, 125b, and 125c, respectively (FIG. 7).

In use, when a first type of material (e.g., a first recyclable) is ready for collection, the cylindrical container 120 is rotated (if necessary) with respect to the truck body 110 such that the first compartment 120a is in the bottom position and aligned with the hopper 140 (FIG. 3A). The first material is then loaded onto the hopper 140, and moved into the first compartment 120a via the ram assembly 150. When a second type of material (e.g., a second recyclable) is ready for collection, the cylindrical container 120 is rotated (if necessary) with respect to the truck body 110 such that the second compartment 120b is in the bottom position and aligned with the hopper 140. The second material is then loaded onto the hopper 140, and moved into the second compartment 120b via the ram assembly 150 (FIG. 3B). When a third type of material (e.g., a third recyclable) is ready for collection, the cylindrical container 120 is rotated (if necessary) with respect to the truck body 110 such that the third compartment 120c is in the bottom position and aligned with the hopper 140. The third material is then loaded onto the hopper 140, and moved into the third compartment 120c via the ram assembly 150.

To unload the material from the cylindrical container 120, various methods can be used. The ejector 164 can be moved distally to push the contents out from the lower compartment (e.g., 120a) (FIG. 3D), then the cylindrical container 120 can be rotated so that a different compartment (e.g., 120b) is at the bottom, followed by the ejector 164 moving distally again to empty the contents therein, and then the cylindrical container 120 can be rotated so that the final compartment (e.g., 120c) is at the bottom, followed by the ejector 164 moving distally for a third time to empty the contents of that compartment. Another way to empty the cylindrical container 120 is to employ the use of three ejectors 164, which may be independently actuated to empty their respective compartment 120a, 120b or 120c (without the need to rotate the cylindrical container 120).

Further, the cylindrical container 120 can be emptied by dumping the contents by elevating the proximal portion of the cylindrical container 120 with respect to the distal portion of the cylindrical container 120. Here, it is disclosed that the distal wall 156 acts as a physical barrier to prevent the contents from two of the compartments from being emptied so the contents in each compartment can be individually emptied—only the compartment that is on the bottom. After the bottom compartment is emptied, the cylindrical container 120 can be rotated, and other compartments can be similarly individually emptied.

While the accompanying figures illustrate the cylindrical container 120 including three compartments 120a, 120b, and 120c, more or fewer compartments may be included within cylindrical container 120. Here, the shape of the ram 154, the opening 158, and the ejector 164 would match or substantially match the cross-sectional shape of each compartment.

Methods of using truck 100, and methods of collecting material are also included by the present disclosure. For example, disclosed methods include loading the first compartment 120a of the cylindrical container 120 with a first material, rotating the cylindrical container 120, loading the second compartment 120b of the cylindrical container 120 with a second material, rotating the cylindrical container 120, and/or loading the third compartment 120c of the cylindrical container 120 with a third material. Other steps of disclosed methods include using the ram 154 to move material proximally within a compartment 120a, 120b, 120c, and using the ejector 164 to move material distally out of the compartment 120a, 120b, 120c.

Although the illustrative embodiments of the present disclosure have been described herein with reference to the accompanying drawings, it is to be understood that the disclosure is not limited to those precise embodiments, and that various other changes and modifications may be affected therein by one skilled in the art without departing from the scope or spirit of the disclosure. All such changes and modifications are intended to be included within the scope of the appended claims.

While embodiments of the disclosure have been shown in the figures, it is not intended that the disclosure be limited thereto, as it is intended that the disclosure be as broad in scope as the art will allow and that the specification be read likewise. Therefore, the above description should not be construed as limiting, but merely as exemplifications of various embodiments. Those skilled in the art will envision other modifications within the scope and spirit of the claims appended hereto.

1. A vehicle, comprising:
a truck body; and
a cylindrical container supported by the truck body, the cylindrical container defining a longitudinal axis and being rotatable about the longitudinal axis with respect to the truck body, the cylindrical container defining a first compartment, a second compartment, and a third compartment therein.

2. The vehicle according to claim 1, wherein each of the first compartment, the second compartment, and the third compartment includes a pie-shaped cross-section.

3. The vehicle according to claim 1, further comprising a ram configured to move at least partially within the cylindrical container.

4. The vehicle according to claim 3, wherein each of the first compartment, the second compartment, and the third compartment includes a pie-shaped cross-section, and wherein the ram is pie-shaped.

5. The vehicle according to claim 1, further comprising a hopper disposed adjacent a distal portion of the cylindrical container.

6. The vehicle according to claim 5, wherein the hopper includes an arcuate bottom member having a curvature that is substantially similar to a curvature of the cylindrical container.

7. The vehicle according to claim 1, further comprising an ejector assembly configured to urge material from within the cylindrical compartment distally.

8. The vehicle according to claim 7, wherein the ejector assembly includes a pie-shaped ejector that is longitudinally translatable within the first compartment.

9. A method of collecting recyclables, the method comprising:
positioning a first compartment of a cylindrical container of a truck in a lower position;
loading a first type of recyclable at least partially into the first compartment;
rotating the cylindrical container with respect to a truck body such that a second compartment of the cylindrical container is in a lower position; and
loading a second type of recyclable at least partially into the second compartment.

10. The method according to claim 9, further comprising rotating the cylindrical container with respect to the truck body such that a third compartment of the cylindrical container is in a lower position.

11. The method according to claim 10, further comprising loading a third type of recyclable at least partially into the third compartment.

12. The method according to claim 9, further comprising moving the first type of recyclable proximally using a pie-shaped ram.

13. The method according to claim 9, further comprising moving the first type of recyclable distally using a pie-shaped ejector.

14. The method according to claim 9, further comprising loading the first type of recyclable onto a hopper of the truck.

15. The method according to claim 14, wherein loading the first type of recyclable onto the hopper of the truck is performed prior to loading the first type of recyclable at least partially into the first compartment.

16. The method according to claim 9, wherein loading the first type of recyclable at least partially into the first compartment is performed prior to rotating the cylindrical container with respect to the truck body such that the second compartment is in the lower position.
